(19) United States
(12) Patent Application Publication
(10) Pub. No.: US 2026/0045468 A1
(43) Pub. Date: Feb. 12, 2026

(54) ARRANGEMENT AND A METHOD FOR A SUBSTANCE DETECTION

(71) Applicant: Karsa Oy, Helsinki (FI)

(72) Inventors: Aleksei SHCHERBININ, Helsinki (FI); Jyri MIKKILÄ, Helsinki (FI); Hans-Jurg JOST, Helsinki (FI)

(21) Appl. No.: 18/797,291

(22) Filed: Aug. 7, 2024

(51) Int. Cl. H01J 49/04; H01J 49/00

(52) U.S. Cl. CPC H01J 49/0422; H01J 49/0036; H01J 49/0409

(57) ABSTRACT

Generally, the present invention relates to vapor interrogation of objects and materials in order to detect dangerous goods or quantitatively interrogate a sample for chemical composition, for example. The arrangement for a substance detection according to the present invention comprises a sampling chamber, wherein the sampling chamber is environmentally isolated, a flow generation unit to provide a sampling flow fluid for the sampling chamber, an intake manifold to introduce the sampling flow into the sampling chamber, a collector manifold to direct the sampling flow out from the sampling chamber, and an ionization and analyzing unit to receive the sampling flow from the sampling chamber through the collector manifold.

This invention was made with U.S. Government support under Agreement No. 70RSAT23T00000001 awarded by the U.S. Department of Homeland Security, Science and Technology Directorate to Karsa. The Government has certain rights in the invention.

### FIELD OF THE INVENTION

Generally, the present invention relates to an arrangement and a method for a substance detection. In particular, the present invention pertains to vapor interrogation of objects and materials.

### BACKGROUND

Objects and their materials outgas a wide variety of chemicals and hence it is possible to study and characterize these objects based on the outgassing chemicals. For instance, canines are used to detect illicit drugs and explosives based on chemicals outgassing from these substances. The process on its own is known and is used in many industries and applications. Mass spectrometry-based trace analysis systems have been developed to analyze gases for chemical composition to a high degree of precision and sensitivity and to detect substances, such as explosives or drugs.

However, the interrogation of object still poses significant challenges in reliability and reproducibility. For instance, prior art does not consider baseline variability of trace compounds in air, negative effects of absolute humidity on chemical analysis and cross contamination of samples in exposed systems.

WO2018050961 A1 discloses a system designed for screening small to medium-sized luggage for traces of unauthorized substances. The primary principle of this invention is the use of an airflow system that collects particles from the surface of items. The collected particles are then concentrated using a virtual impactor before being analyzed by a mass spectrometer. The system includes a sampling tunnel installed over a conveyor belt, where air jets dislodge particles from luggage surfaces. These particles are then directed into the virtual impactor, which separates them based on size and mass, facilitating a detection process.

U.S. Pat. No. 11,562,894 B1 presents a trace sampling system integrated with a conventional conveyor-based imaging scanner. The core principle of this invention is to eliminate the need for manual sampling by using heaters and evaporators to vaporize chemicals from the surface of objects, such as luggage, as they move through the conveyor system. The vapors are then collected and directed to a mass spectrometry detector for analysis. This system is designed to operate automatically and continuously, providing a process for detecting trace amounts of substances without the need for manual intervention.

Unfortunately, arrangements in the prior art are often open systems arranged on the top of a conveyor belt, for example. These kinds of open configurations present significant challenges, particularly when sampling potentially small amounts of substances in the gaseous phase. These challenges stem from the inability to maintain stable conditions, as external contaminants and fluctuations in environmental factors like temperature and humidity can easily infiltrate the sampling area and affect analytical capabilities of the system. Such variability compromises the accuracy and reproducibility of results, as the presence of background noise and unintended contaminants as well as varied environmental conditions can skew data and lead to erroneous conclusions. Additionally, open systems are more susceptible to cross-contamination, where residues from previous samples can affect the analysis of subsequent ones. This not only increases the likelihood of false alarms but also diminishes the overall reliability and efficiency of the detection system. Consequently, ensuring precise and dependable sampling becomes far more difficult in open configurations, highlighting the need for more controlled and isolated sampling environments.

### SUMMARY OF THE INVENTION

The objective is to at least alleviate the problems described hereinabove not satisfactorily solved by the known arrangements, and to provide a feasible arrangement and a method for detecting substances in a controlled and reproducible manner.

An arrangement for a substance detection according to the present disclosure has been indicated in an independent claim 1.

Accordingly, in one aspect of the present invention an arrangement for a substance detection comprises a sampling chamber, wherein the sampling chamber is environmentally isolated, a flow generation unit to provide a sampling flow fluid for the sampling chamber, an intake manifold to introduce the sampling flow into the sampling chamber, a collector manifold to direct the sampling flow out from the sampling chamber, and an ionization and analyzing unit to receive the sampling flow from the sampling chamber through the collector manifold.

In one embodiment, the sampling chamber is hermetically closed. The hermetically closed sampling chamber may provide improved conditions for the sampling of potentially small amounts of substances on gaseous phase.

In one embodiment, the arrangement further comprises climate control means to detect and control the temperature and/or humidity inside the sampling chamber.

In one embodiment, the arrangement further comprises a pressure control means to detect and control the pressure inside the sampling chamber.

In one embodiment, the fluid used as a sampling flow is selected from a group consisting of nitrogen, argon, air, and any combination thereof. These fluids offer several advantages for substance detection. Nitrogen and argon are inert and non-reactive, minimizing the risk of chemical reactions with the sample and maintaining its integrity. Air, while more reactive, is readily available and can be effectively filtered and purified. Using any of these fluids or their combination may help to create a stable and controlled environment within the sampling chamber, which is crucial for achieving accurate and reproducible results. Nitrogen and argon reduce the likelihood of contamination, ensuring precise analysis, while air offers practicality and cost-effectiveness. The ability to combine these fluids provides flexibility, enhancing the system's versatility and effectiveness in detecting various substances.

In one embodiment, the arrangement further comprises means to flush the sampling chamber for cleaning the sampling chamber from possible residues.

In one embodiment, the flow generation unit comprises one or more compressors, one or more fluid source and a gas conditioning unit for providing continuous source of dry and clean fluid flow to the sampling chamber and for keeping a stable chemical background within the sampling chamber.

In one embodiment, the gas conditioning unit comprises one or more component from a group consisting of one or more dryers, one or more containers filled with molecular sieves, activated carbon, soda lime and any other adsorbent purifying fluid.

In one embodiment, the intake manifold is configured to provide a plug flow for the fluid flow.

In one embodiment, the configuration of the collector manifold is symmetric to the intake manifold.

In one embodiment, the ionization and analyzing unit comprises at least an Ion Molecule Reactor (IMR) and analyzing means.

In one embodiment, the analyzing means comprises a chemical ionization mass spectrometer to analyze the chemical composition of the gas.

In one embodiment, the analyzing means comprises an ion mobility spectrometer to analyze the chemical composition of the gas.

In one embodiment, the volume of the sampling chamber is configured to be adjustable.

In one embodiment, the flow generation unit is arranged to programmatically vary flow speeds during sampling to optimize detection and/or to reduce sampling time.

A method for a substance detection according to the present disclosure has been indicated in an independent claim 16.

Accordingly, in one aspect of the present invention a method for a substance detection comprises at least the steps of
placing the object to be to be detected in said sampling chamber,
introduce the sampling flow into said sampling chamber,
directing the sampling flow out from said sampling chamber and introducing it into said ionization and analyzing unit, and
analyzing said sampling flow to identify dangerous goods or to quantitatively analyze a sample for its chemical composition.

In one embodiment, the method further comprises a step of adjusting the volume of said sampling chamber.

In one embodiment, the method further comprises a step of continuously collect background measurements in order to be trained to retrieve data only from outgassing objects and to ignore constantly present chemical signals that belong to the background.

In one embodiment, the method further comprises a step of arranging the arrangement to use supervised, semi-supervised or unsupervised machine learning algorithms to determine the chemical fingerprint characteristic of particular object classes and/or compositions.

The utility of the present invention follows from a plurality of factors depending on each particular embodiment. The environmentally isolated or hermetically closed sampling chamber of the present invention has many advantages. By ensuring an airtight environment, it may be possible to provide stable conditions for the sampling of potentially small amounts of substances in the gaseous phase. Additionally, the environmentally isolated or hermetically sealed chamber may prevent external contaminants and environmental fluctuations, such as changes in temperature and humidity, from affecting the sample. This isolation minimizes the 20 risk of cross-contamination from previous samples and reduces background noise, thereby enhancing the accuracy and reproducibility of the results. Moreover, maintaining a controlled and stable environment within the chamber may allow for more precise detection of trace compounds, which is crucial for applications requiring high sensitivity and reliability, such as detecting explosives or illicit drugs. This improvement in sampling conditions may lead to a more efficient and dependable substance detection system.

The precise regulation of temperature and humidity also offers significant benefits. Maintaining a constant, slightly elevated temperature prevents condensation and phase transitions of water, which can interfere with the accuracy of substance detection, especially when dealing with trace amounts. Controlling humidity prevents external moisture from entering the chamber, ensuring a stable and uncontaminated sampling environment. This stability is crucial for achieving reproducible results, as fluctuations in humidity can alter the chemical properties of the sample or introduce noise.

Additionally, climate control may enhance the overall efficiency and reliability of the detection system by providing consistent conditions that allow for more accurate identification of substances such as explosives or illicit drugs. This consistency reduces the likelihood of false positives or negatives, increasing the system's overall dependability. Integrating climate control within the sampling chamber optimizes conditions for precise and reproducible substance detection, significantly enhancing the system's performance and reliability.

The configuration of the intake and/or collector and/or sampling chamber manifold can provide non-turbulent or plug flow in the arrangement of the present invention. The advantages of plug flow include the minimization of axial mixing, ensuring that all parts of the fluid move at the same velocity and experience the same conditions as they travel through the sampling chamber. This uniform flow profile may lead to more accurate and reproducible sampling, as the fluid's exposure to the sample is consistent throughout the process. Additionally, plug flow reduces the likelihood of dead zones or areas where the fluid might stagnate, thereby enhancing the efficiency of substance detection. This controlled and predictable flow pattern is particularly beneficial in detecting trace amounts of substances, as it may allow for precise timing and placement of the sample within the analysis apparatus, leading to more reliable and sensitive detection results.

The adjustable volume of the sampling chamber may allow it to accommodate a variety of object sizes and shapes, providing flexibility for different analytical requirements. This capability is particularly useful when dealing with objects of varying dimensions, ensuring that the sampling process remains efficient and effective regardless of the object's size. Furthermore, this adaptability can lead to more accurate and representative sampling results, as the chamber can be precisely tailored to the specific needs of each analysis.

The expression “a number of” refers herein to any positive integer starting from one (1), e.g. to one, two, or three.

The expression “a plurality of” refers herein to any positive integer starting from two (2), e.g. to two, three, or four.

Different embodiments of the present invention are disclosed in the dependent claims.

### BRIEF DESCRIPTION OF THE RELATED DRAWINGS

Next the invention is described in more detail with reference to the appended drawings in which

FIG. 1 illustrates an embodiment of an arrangement for a substance detection in accordance with the present invention, and

FIG. 2 is a flow diagram of an embodiment of a method in accordance with the present invention.

### DETAILED DESCRIPTION OF THE EMBODIMENTS

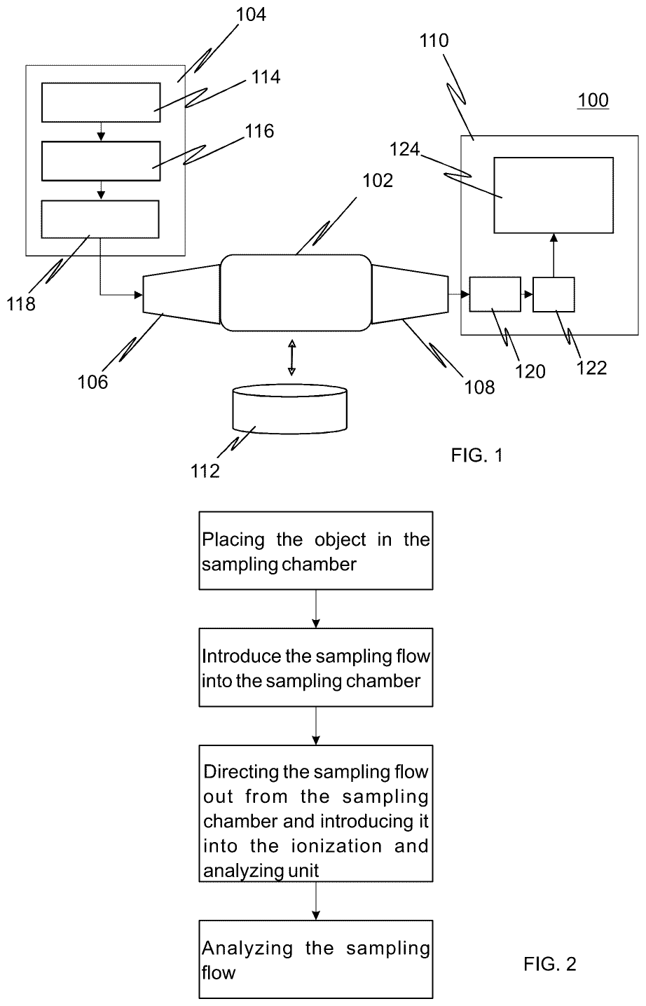

FIG. 1 illustrates an embodiment of an arrangement for substance detection in accordance with the present invention. An arrangement 100 for substance detection comprises a sampling chamber 102, a flow generation unit 104 to provide a sampling flow fluid for the sampling chamber 102, an intake manifold 106 to introduce the sampling flow into the sampling chamber, a collector manifold 108 to direct the sampling flow out from the sampling chamber 102, and an ionization and analyzing unit 110 to receive the sampling flow from the sampling chamber through the collector manifold.

The sampling chamber is operationally closed (sealed) from the environment to create constant, stable and controlled flow of purified gas through the chamber. In an embodiment, the sampling chamber is hermetically isolated.

The object to be detected is denoted in FIG. 1 with 112. In FIG. 1, the object 112 is depicted outside of the sampling chamber 102. In an embodiment, the sampling chamber comprises a sealed door (not shown) for convenience in placing and removing objects. In an embodiment, the sampling chamber comprises a tray (not shown) on which the object can be placed.

The present invention is suitable for detecting substances from various kinds of objects. Depending on the embodiment, the volume of the sampling chamber may vary. The volume of the sampling chamber can be 1 L-10 L for the analysis of small amounts of materials and small objects e.g. vials, for example. For bigger objects, such as mail, consumer electronics etc., the volume of the sampling chamber can be 10 L-100 L, for example. A skilled person will understand that the volume of the sampling chamber is not limited to these sizes, but the volume of the sampling chamber can be more than 100 L or less than 1 L if required.

In an embodiment, the volume of the sampling chamber is configured to be adjustable. In an embodiment, the volume of the sampling chamber is adjusted changing the distance between the walls. In another embodiment, it is performed by altering the height of the floor, for example. For instance, movable walls can slide closer together or further apart to decrease or increase the chamber's volume respectively. Similarly, the floor of the chamber can be designed to be adjustable, either by raising or lowering it, thereby modifying the internal space in the sampling chamber.

In an embodiment, the sampling chamber 102 has a geometry advantageously chosen to minimize the path of outgassing chemicals from the object to the ionization and analyzing unit 110, consisting of a minimal number of parts, such as the intake manifold 106, the collector manifold 108 and the sampling chamber 102 all chosen to create a well-developed, non-turbulent sampling flow of fluid and to minimize chemical background.

In an embodiment, the arrangement further comprises climate control means to detect and control the temperature and/or humidity inside the sampling chamber. A skilled person will understand that the climate control means can comprise several devices, such as but not limited to, one or more heaters, one or more coolers and/or one or more means to control humidity. It is advantageous that the walls of the sampling chamber and the flow directed to the sampling chamber are kept at a uniform temperature, which can be slightly elevated compared to the ambient temperature to avoid condensation due to phase transition phenomena of water and condensation of other substances, and to ensure reproducibility of substance detection.

In an embodiment, the arrangement further comprises a pressure control means to detect and control the pressure inside the sampling chamber.

In an embodiment, the flow generation unit 104 comprises a fluid source 114, one or more compressor 116, and a gas conditioning unit 118 for providing continuous source of dry and clean fluid flow to the sampling chamber and for keeping a stable chemical background within the sampling chamber.

In an embodiment, the gas conditioning unit 118 comprises one or more component from a group consisting of one or more dryers, one or more containers filled with molecular sieves, activated carbon, soda lime and any other adsorbent purifying fluid.

In an embodiment, the fluid source comprises one or more fluid selected from a group consisting of nitrogen, argon, air and any combination thereof. The fluid source can comprise one or more nitrogen generators, one or more cryogenic containers and/or bottled gases.

In an embodiment, the fluid flow rate is selected to be from 1 to 100 liters per minute. A skilled person will understand that another fluid flow rate can also be selected.

In an embodiment, the flow generation unit is arranged to programmatically vary flow speeds during sampling to optimize detection and/or to reduce sampling time. In an embodiment, the flow rate is initially higher to quickly move the vapors from the object to be detected in the sampling chamber to the ionization and analyzing unit. The flow rate is then slowed down to increase the fraction of the flow being sampled versus flushed.

In an embodiment, the flow rate is increased to the highest setting after the sampling to purge the sampling chamber and remove contamination. In an embodiment, the arrangement further comprises means to purge the sampling chamber to clean it from possible residues. In an embodiment, the flow generation unit 104 is used for purging the sampling chamber. In another embodiment, the arrangement comprises another means for purging the sampling chamber.

The intake manifold 106 of the present invention, designed to introduce the sampling flow into the sampling chamber 102, is arranged between the flow generation unit 104 and the sampling chamber 102. In an embodiment, the geometry of the intake manifold 106 is designed to develop a non-turbulent flow by avoiding bends and wall losses. This can be achieved by configuring the intake manifold with an expanding geometry so that the larger side of the intake manifold is arranged at the sampling chamber end. In another embodiment, the intake manifold is designed to provide a plug flow for the fluid flow.

The collector manifold 108 of the present invention, designed to direct the sampling flow out from the sampling chamber 102, is arranged between the sampling chamber 102 and the ionization and analyzing unit 110. In an embodiment, the configuration of the collector manifold 106 is symmetric to the intake manifold. In case wherein the collector manifold has an expanding geometry, the larger side of the collector manifold is arranged at the sampling chamber end.

In an embodiment, the ionization and analyzing unit 110 to receive the sampling flow from the sampling chamber through the collector manifold comprises at least an Ion Molecule Reactor (IMR) 120 and analyzing means 122. The IMR of the chemical ionization system ionizes neutral molecules of the gaseous sample. Preferably, the IMR exhaust is connected to the vacuum system to generate a vacuum equal to the positive pressure flow through the intake manifold, thus creating a unified continuous flow through the arrangement. A chemical ionization source, such as a corona discharger, radioactive ion source, or soft x-ray source, produces ions used in the ionization of neutral molecules. According to an embodiment variant, ionization is performed selectively by the chemical ionization method.

In an embodiment, the analyzing means 122 comprises a chemical ionization mass spectrometer to analyze the chemical composition of the gas. In another embodiment, the analyzing means 122 comprises an ion mobility spectrometer to analyze the chemical composition of the gas. These techniques are well-known in the state of the art and are therefore not described in further detail.

In an embodiment, the ionization and analyzing unit 110 further comprises a computer system 124 to collect and store chemical spectra and to provide means for the chemical analysis. In an embodiment, the computer system 124 is used as a detector to identify dangerous goods or to quantitatively analyze a sample for its chemical composition.

In an embodiment, the computer system 124 is arranged to continuously collect background measurements, and therefore the system 124 can be trained to retrieve data only from outgassing objects and ignore constantly present chemical signals that belong to the background. This method can be used as a feature reduction step to compress the output data.

In an embodiment, the computer system 124 and related database are trained to recognize particular objects using supervised, semi-supervised or unsupervised machine learning algorithms to determine the chemical fingerprint characteristic of particular object classes and/or compositions.

A skilled person will understand that the arrangement of the present invention can also comprise the infrastructure for electricity, pumps, vacuum pumps, pneumatics, etc., as well as data processing and control electronics of the analysis apparatus according to the type in use.

FIG. 2 is a flow diagram of an embodiment of method for a substance detection in accordance with the present invention.

At 202, the object to be to be detected is placed in the sampling chamber.

At 204, the sampling flow is introduced into the sampling chamber.

At 206, the sampling flow is directed out from the sampling chamber and introducing it into the ionization and analyzing unit.

At 208, the sampling flow is analyzed in the ionization and analyzing unit to identify dangerous goods or to quantitatively analyze a sample for its chemical composition.

In an embodiment, the method further comprises a step of adjusting the volume of said sampling chamber.

In an embodiment, the method further comprises a step of arranging the arrangement to continuously collect background measurements in order to be trained to retrieve data only from outgassing objects and to ignore constantly present chemical signals that belong to the background.

In an embodiment, the method further comprises a step of arranging the arrangement to use supervised, semi-supervised or unsupervised machine learning algorithms to determine the chemical fingerprint characteristic of particular object classes and/or compositions.

Consequently, a skilled person may on the basis of this disclosure and general knowledge apply the provided teachings in order to implement the scope of the present invention as defined by the appended claims in each particular use case with necessary modifications, deletions, and additions.

1. An arrangement for a substance detection comprising
a sampling chamber, wherein said sampling chamber is environmentally isolated,
a flow generation unit to provide a sampling flow fluid for said sampling chamber,
an intake manifold to introduce said sampling flow into said sampling chamber,
a collector manifold to direct said sampling flow out from said sampling chamber, and
an ionization and analyzing unit to receive said sampling flow from said sampling chamber through said collector manifold.

2. The substance detection arrangement of claim 1, wherein said sampling chamber is hermetically closed.

3. The substance detection arrangement of claim 1, wherein said arrangement further comprises climate control means to detect and control the temperature and/or humidity inside said sampling chamber.

4. The substance detection arrangement of claim 1, wherein said arrangement further comprises a pressure control means to detect and control the pressure inside said sampling chamber.

5. The substance detection arrangement of claim 1, wherein said fluid is selected from a group consisting of nitrogen, argon, air and any combination thereof.

6. The substance detection arrangement of claim 1, wherein said arrangement further comprises means to flush said sampling chamber for cleaning said sampling chamber from possible residues.

7. The substance detection arrangement of claim 1, wherein said flow generation unit comprises one or more compressors, one or more fluid source and a gas conditioning unit for providing continuous source of dry and clean fluid flow to said sampling chamber and for keeping a stable chemical background within said sampling chamber.

8. The substance detection arrangement according to claim 7, wherein said gas conditioning unit comprises one or more component from a group consisting of one or more dryers, one or more containers filled with molecular sieves, activated carbon, soda lime and any other adsorbent purifying fluid.

9. The substance detection arrangement of claim 1, wherein said intake manifold is configured to provide a plug flow for said fluid flow.

10. The substance detection arrangement of claim 1, wherein the configuration of said collector manifold is symmetric to said intake manifold.

11. The substance detection arrangement of claim 1, wherein said ionization and analyzing unit comprises at least an Ion Molecule Reactor (IMR) and analyzing means.

12. The substance detection arrangement according to claim 11, wherein said analyzing means comprises a chemical mass spectrometer to analyze the chemical composition of the gas.

13. The substance detection arrangement according to claim 11, wherein said analyzing means comprises an ion mobility spectrometer to analyze the chemical composition of the gas.

14. The substance detection arrangement of claim 1, wherein the volume of said sampling chamber is configured to be adjustable.

15. The substance detection arrangement of claim 1, wherein the flow generation unit is arranged to programmatically vary flow speeds during sampling to optimize detection and/or to reduce sampling time.

16. A method for a substance detection comprising an arrangement according to claim 1, wherein said method comprises at least the steps of
placing the object to be to be detected in said sampling chamber,
introduce the sampling flow into said sampling chamber,
directing the sampling flow out from said sampling chamber and introducing it into said ionization and analyzing unit, and
analyzing said sampling flow to identify dangerous goods or to quantitatively analyze a sample for its chemical composition.

17. The method according to claim 16 further comprising a step of adjusting the volume of said sampling chamber.

18. The method according to claim 16 further comprising a step of arranging said arrangement to continuously collect background measurements in order to be trained to retrieve data only from outgassing objects and to ignore constantly present chemical signals that belong to the background.

19. The method according to claim 16 further comprising a step of arranging said arrangement to use supervised, semi-supervised or unsupervised machine learning algorithms to determine the chemical fingerprint characteristic of particular object classes and/or compositions.
